(19) United States
(12) Patent Application Publication
(10) Pub. No.: US 2006/0068674 A1
(43) Pub. Date: Mar. 30, 2006

(54) Novel laminates for producing high strength porous sterilizable packaging

(76) Inventors: Ajit S. Dixit, Morrisville, NC (US); Melvin G Mitchell, Penrose, NC (US); Thomas E Hair, Beaumont, TX (US); Herbert D Stroud JR., Rutherfordton, NC (US); Edward K Burmeister, Nunica, MI (US)

Correspondence Address: Louis M Heidelberger;Reed Smith, 2500 One Liberty Place, 1650 Market Street, Philadelphia, PA, 19103, US

(21) Appl. No.: 10/504,611

(22) PCT Filed: Feb. 13, 2003
(86) PCT No.: PCT/US03/04586

§ 371 Date: Sep. 1, 2005

Related U.S. Application Data
(60) Provisional application No. 60/356,646, filed on Feb. 13, 2002.

(51) Int. Cl. B32B 29/02; B32B 27/04

(52) U.S. Cl. 442/412; 442/123; 442/153; 442/164; 428/131; 428/137; 428/138; 428/537.7

(57) ABSTRACT

A novel approach is offered to produce a sterilizable medical package by laminating either a nonwoven fabric or a perforated film to a paper web. The laminate construction exhibits properties of heat stability, strength, microbial barrier, air/gas permeability and printability. The laminate construction becomes a self-sealing package that can be sterilized by various techniques, e.g. autoclave (heat), ethylene oxide or gamma radiation.

### CROSS-REFERENCE TO RELATED APPLICATIONS

This application claims the benefit under 35 U.S.C. § 119(e) of the earlier filing date of U.S. Provisional Patent Application Ser. No. 60/356,646 filed on Feb. 13, 2002.

### STATEMENT REGARDING FEDERALLY SPONSORED RESEARCH OR DEVELOPMENT

Not Applicable

### REFERENCE TO A “MICROFICHE APPENDIX”

Not Applicable

### BACKGROUND OF THE INVENTION

1. Field of the Invention

The present invention relates generally to the field of medical packaging materials. More particularly, the present invention relates to an improved sterilizable laminate that is flexible, non-rigid, air/gas-permeable, steam permeable and impermeable to microbes. The laminate of the present invention also provides a superior printable surface for the sterilizable package.

2. Description of the Related Art

Sterilizable packaging has been widely used for medical packaging for the storage, transportation and handling of medical devices. Such devices include sutures, clamps, needles, gauze, scalpels, prosthetics and other accessories. Typically, such a product is placed into a package, sealed, and then subjected to conditions that will sterilize the sealed contents of the package. Good seal strength is necessary to maintain package integrity during storage, transportation and handling. On the other hand, the package must be capable of being easily opened when the medical device is needed.

During heat sterilization, the packaging must be permeable to both air and steam so that gas inside the package can diffuse. However, the package must also resist the entry of bacteria and pathogens during and after the sterilization process, keeping the package and its contents sterile until opening. Without sufficient air permeability, sterilization may cause the seal to open due to the build up of pressure inside the package. High porosity also allows an increased rate of air/gas movement through the material, which can improve sterilization efficiency. U.S. Pat. No. 5,342,673 to Bowman, et al. discloses that “for dry heat sterilization, a package is needed that can withstand temperatures in excess of 135° C.,” and further states that “[c]urrently used materials, such as polyolefins as represented by Tyvek®, deform or shrink under these temperature conditions.”

Other methods of sterilizable packaging include double-layered muslin cloth (CSR wrap), steel or plastic trays, paper/film pouches and kraft paper wrap (coated and uncoated). Sterilization practices involving CSR wrap provide good bacterial barrier, but are costly due to the material and labor intensity of the process.

Steel and plastic trays are re-usable, but expensive. Further, as disclosed in U.S. Pat. No. 6,251,489 to Weiss et al., they “have considerable mass which gives rise to a problem of sterilant condensate which arises with this method of sterilization.”

As described in Weiss et al., kraft paper packages, whether coated or uncoated, can generate debris and cause the generation of loose paper fibers—an undesirable situation in an operating room or other area where dust is desirably kept to a minimum. Paper by itself, while porous, would not be sufficient to produce a suitable puncture resistant medical package. Also, a paper-only package may not have sufficient tear resistance to hold larger and heavier medical devices. Tyvek®-type nonwoven fabrics (available from DuPont of Wilmington, Del.) would have sufficient strength and tear resistance, but not the resistance to shrinkage in high temperature steam sterilization, as they are made of high-density polyethylene.

Finally, for pre-packaged sterilized medical devices, many of the above materials are not as suitable for printing. Paper remains the best packaging material for its superior printability to materials such as cloth, film or nonwoven fabrics such as Tyvek®.

Previous attempts to solve one or more of the aforementioned problems have involved the use of laminates, such as film to paper. U.S. Pat. No. 4,367,816 to Wilkes discloses a bag fabricated from a low density polyethylene sheet, which includes a bottom sheet of HDPE coated on each side with a thin layer of a blend of ethyl vinyl acetate (EVA) and low density polyethylene, and a top sheet of surgical paper. The blend of EVA and low density polyethylene is adjusted so that its bond to the HDPE sheet provides the desired peel strength. As disclosed in Wilkes, the HDPE is perforated in a selected area within the seal lines, thereby allowing the sterilizing gas to pass freely. However, this product would exhibit the same problems with heat sterilization that nonwoven fabrics such as Tyvek® encounter, as HDPE tends to shrink under the extreme temperatures necessary for autoclave sterilization. With such materials, package failure under heat may occur.

Therefore, the need exists for a sterilizable packaging material that is not only inexpensive but that also exhibits high strength, appropriate permeability to air/gas and steam while maintaining resistance to undesirable contaminants such as bacteria and pathogens, resistance to shrinkage in high temperature steam sterilization, and minimal or no generation of debris or loose paper fibers upon opening. Further, the need exists for a sterilizable packaging material that not only possesses all of the foregoing properties, but that also provides a high-quality printable surface capable of accommodating a wide array of printing applications.

### SUMMARY OF THE INVENTION

The present invention is a sterilizable packaging material comprised of a laminate that is flexible, non-rigid, air/gas-permeable, steam permeable, and impermeable to microbes. The laminate will be able to tolerate heat sterilization temperatures in excess of 135° C. for extended periods of time without adverse effects. The laminate provides sufficient porosity for air in heat sterilization while providing a barrier to bacteria and pathogens. At the same time, the laminate provides a superior printable surface for the sterilizable package. The basic components of the sterilizable packaging laminate comprise a layer of nonwoven fabric or perforated film, which is laminated to a layer of paper. The combination of paper with nonwoven fabric or perforated film provides a printable, sterilizable package with superior air/gas permeability, heat stability and bacterial barrier.

The present invention, in its various embodiments, addresses one or more limitations in prior art sterilizable laminates and medical packaging materials. Various other objectives and advantages of the present invention will become apparent to those skilled in the art through the following description of the invention and the claims.

### DETAILED DESCRIPTION OF THE PRESENTLY PREFERRED EMBODIMENTS OF THE INVENTION

It is to be understood that the figures and descriptions of the present invention have been simplified to illustrate elements that are relevant for a clear understanding of the present invention, while eliminating, for purposes of clarity, other elements that may be well known. Those of ordinary skill in the art will recognize that other elements are desirable and/or required in order to implement the present invention. However, because such elements are well known in the art, and because they do not facilitate a better understanding of the present invention, a discussion of such elements is not provided herein. Further, throughout the instant disclosure, it will be appreciated that several terms may be used interchangeably with one another.

If not otherwise stated herein, any and all patents, patent publications, articles and other printed publications discussed or mentioned herein are hereby incorporated by reference as if set forth in their entirety herein.

In a first presently preferred embodiment, the sterilizable packaging laminate of the present invention comprises two major components, namely, a layer of nonwoven fabric laminated to a layer of paper. The paper may be kraft or free-sheet (either uncoated or coated). In a second presently preferred embodiment, the laminate comprises a layer of perforated film laminated to a layer of paper.

In the first embodiment, the porous nonwoven fabric layer provides the laminate with air/gas permeability, tear resistance and shrink resistance in heat. The preferred nonwovens would be spunbonded polyester (PET), polypropylene (PP), polyethylene (PE), nylon 6 or nylon 6,6 (N), but other polymers such as polytetrafluoroethylene (PTFE), polyvinylfluoride (PVF), polyvinylchloride (PVC), polyvinylidenefluoride (PVDF), or polyvinylidenechloride (PVDC) could be used. The type of spunbonding could include, for example and in no way intended to be limiting, point-bonding, flat-bonding, embossed-bonding, or any other combinations of heat and pressure to bond the nonwoven fabric. In addition to spunbonding, other methods of nonwoven construction could be considered, such as melt-blown, spunbond-meltblown composite (SMS and SMMMS), carded, wetlaid, thermal-bonded, airlaid and spunlaced. The nonwoven fabric may or may not include a biocide or bactericide that would contribute additive bacterial barrier properties to the nonwoven fabric. The weight of the nonwoven would be anywhere from about 0.5 oz/yd² (approximately 13 g/m²) to about 5 oz/yd² (approximately 130 g/m²) as desired for strength properties of the laminate.

In the second embodiment, wherein the paper layer is laminated to a perforated film layer rather than a nonwoven fabric layer, the preferred film materials include, for example, polyester (PET), polypropylene (PP), nylon 6 or nylon 6,6 (N). Other films such as polytetrafluoroethylene (PTFE), polyvinylfluoride (PVF), polyvinylchloride (PVC), polyvinylidenefluoride (PVDF) or polyvinylidenechloride (PVDC), could be used as well in this embodiment. Films formed by casting, extrusion or any process would be acceptable. The film may or may not include a biocide or bactericide that would contribute additive bacterial barrier properties to the perforated film. Perforation of the above film would provide the air/gas permeability of the laminate, while the inherent strength and heat stability of the film components would provide the necessary characteristics of a sterilizable package. The preferred method of film perforation would be mechanical perforation, where holes are punched through the film. Other methods of perforation, such as laser and electrostatic, could be used as well in preparing a perforated film. The weight of the film could range from about 0.5 oz/yd² (approximately 13 g/m²) to about 3 oz/yd² (approximately 100 g/m²) as desired for strength properties of the laminate.

The paper component would be a kraft or free-sheet paper that contains the properties of air/gas-permeability, printability, surface strength, wet strength, heat-stability and bacterial barrier. In one embodiment, a paper composition is provided which comprises a web and a solution. In a preferred embodiment, the web comprises cellulose fibers, although the web may also comprise synthetic fibers, or a mixture of cellulose and synthetic fibers. Such synthetic fibers could include those treated with a biocide or bactericide that would contribute additive bacterial barrier properties to the paper web.

Various wet end additives are used during the papermaking process to improve the paper properties and enhance process conditions. Among the wet end additives used are alkyl ketene dimer (AKD) or alkyl succinic anhydride (ASA) as sizing agents for water holdout, starch (modified/unmodified) for retention and strength, cellulose derivatives such as carboxymethyl cellulose (CMC) for strength improvement, and wet strength resins such as Kymene (available from Hercules Inc. of Wilmington, Del.).

In a preferred embodiment, a first wet end additive that provides water holdout is added along with the fibers to make a web with holdout properties. A second wet end additive, comprising a cellulose derivative along with a wet strength resin, is added to provide greater strength of the paper web, including both dry web strength and wet web strength. According to the Pulp and Paper Online Dictionary (found at www.paperloop.com), wet strength is defined as “the tensile strength of a sheet of paper when completely wet, sometimes calculated as a percentage of its dry strength,” and a wet strength paper is defined as “a paper in which the fiber constituents and/or the sheet were chemically treated to enhance resistance to tear, rupture, or falling apart after becoming saturated with liquids.” The surface of the paper web may then be treated with other components, such as surface sizing or coating that may enhance the water holdout properties of the web along with the printing characteristics, such as ink receptivity.

The first wet end additive for water holdout comprises an alkaline sizing agent such as AKD or ASA in a water based emulsion with fatty acids. An example of a commercially available AKD size is Hercon 118, available from Hercules Inc. of Wilmington, Del. The wet end additive for dry and wet strength comprises a cellulose derivative, such as CMC, along with a wet strength resin. An example of a suitable CMC is CMC 7LT from Hercules Inc. of Wilmington, Del. An example of a suitable wet strength resin is Kymene 557-LX.

The relative weight percentages of the wet end additives can be adjusted to accommodate the particular product being treated, the particular application method, and the desired end result to be achieved by treating the product with the formulation. The AKD component of the paper web may comprise anywhere from about 0.1% to about 5% of the total composition of the paper web. The water dispersible CMC may comprise anywhere from about 0.1% to about 5% of the total composition of the paper web. The wet strength agent may comprise anywhere from about 0.1% to about 5% of the total composition of the paper web. In a preferred embodiment, the AKD comprises from about 0.2% by weight to about 2% by weight, and in a more preferred embodiment, from about 0.5% by weight to about 1% by weight. In a preferred embodiment, the CMC comprises from about 0.3% by weight to about 3% by weight, and in a more preferred embodiment, from about 1% by weight to about 2% by weight. In a preferred embodiment, the wet strength resin comprises from about 0.3% by weight to about 3% by weight, and in a more preferred embodiment, from about 1% by weight to about 2% by weight.

The paper web coating solution could comprise of any chemical or polymer that enhances water holdout and printability of the paper portion of the laminate. Such property-enhancing components include, for example, biocides, bactericides, anti-microbial coatings, cellulose derivatives and gums, polyvinyl alcohol, optical brighteners, synthetic resins (PE, PET, EVA and the like), food grade dyes, latex, lubricants, dispersants and print-enhancing resins such as styrene-maleic anhydride.

Any suitable polyvinyl alcohol may be used for that component of the coating solution that provides water holdout. Molecular weight and the degree of hydrolysis control the physical properties of polyvinyl alcohol, and polyvinyl alcohol manufacturers offer a wide range of grades. Hydrolysis and molecular weight can be independently controlled in the manufacturing process, so as to provide the desired property balance for different applications. In the preferred embodiment, the polyvinyl alcohol component comprises a fully hydrolyzed polyvinyl alcohol with a medium molecular weight. An example of a commercially available polyvinyl alcohol which is intermediately hydrolyzed and which possesses a medium molecular weight is Airvol 165, available from Air Products Co. of Allentown, Pa. Airvol 165 possesses properties of a fully hydrolyzed grade of polyvinyl alcohol. It has a strong affinity for hydrophilic surfaces such as cellulosics.

The relative weight percentages of the paper web coating components can be adjusted to produce a paper web with the desired combination of bacterial barrier, printability, air/gas-permeability and web strength. The amount of solution applied to the web component to form the paper composition can be adjusted to accommodate the particular product being treated, the particular application method, and the desired end result to be achieved by treating the product with the formulation. In one embodiment, the solution may comprise anywhere from about 0.5% by weight to about 10% by weight of the paper composition (the remaining weight percentage being attributed to the web). In a preferred embodiment, the solution comprises from about 1% by weight to about 11% by weight, and in a more preferred embodiment, from about 2% by weight to about 7% by weight.

A defoaming agent and biocide agent may be added to the solution, if desired.

The components of the present invention have synergistic effect. That is, the combination of a nonwoven fabric with paper or perforated film with paper provides enhanced properties, in several respects, than the same properties provided by each of the individual components standing alone. This is demonstrated in the examples below.

The variety of products with which the design of the present invention could be used is infinite. For example, and in no way intending to limit the scope of the present invention in any way, the present invention could be used to provide sterilizable medical packaging for assorted devices such as sutures, clamps, needles, gauze, scalpels, prosthetics, trays and so forth. Also, in no way intending to limit the scope of the present invention in any way, the present invention could be sterilized in several ways, such as autoclave sterilization (through heat), ethylene oxide gas sterilization, gamma radiation sterilization and other methods of sterilization.

This composite can also be used in areas where moisture vapor transmission or gas transmission is crucial or critical. Such applications would include, by way of example only and in no way intended to be limiting, applications such as packaging for desiccants, sachets, fragrance pouches, oxygen scavengers and odor-absorbing materials. The laminate construction of nonwoven fabric with paper or perforated film with paper would allow moisture vapor and gas to transfer in and out of the package, enabling the contents within the laminate package to perform its function.

In one embodiment, a nonwoven fabric laminated to a porous paper could form a package for a desiccant, a material that absorbs moisture vapor from the surrounding air. With the heat resistant laminate of nonwoven fabric and paper, a desiccant can be regenerated, or prepared for re-use, simply by placing the package and desiccant together into a regeneration oven. Such an oven would elevate the package and desiccant to a temperature of 245° F. for an extended amount of time, during which the water vapor is completely removed from the desiccant and the package, regenerating a desiccant and allowing it and the package to be re-used. The heat-resistance of the laminate would allow multiple regeneration and re-use of packaged desiccants.

Another area where the laminate composite can provide moisture vapor transmission or gas transmission is in house wrapping material. House wrapping material should provide a barrier to bulk water, such as precipitation—ice, rain, sleet and snow, yet allow moisture vapor transmission across the wrap to prevent molding and rotting of siding and other home-building materials. The paper web portion of the laminate provides the water resistance of the laminate, while the perforated film or nonwoven fabric allows for moisture vapor transmission. Adjusting the amount of internal sizing agent such as AKD, along with adjustments to the type and amount of surface sizing or coating can provide a paper web that provides the best bulk water holdout while allowing the house-wrap laminate material to transfer moisture vapor, or “breathe.”

In a preferred embodiment, the laminates of a nonwoven fabric with paper or perforated film with paper are constructed using an adhesive applied to the paper, which holds the two layers together. In another preferred embodiment, the laminates of a nonwoven fabric with paper or perforated film with paper are constructed using an adhesive applied to the perforated film or nonwoven fabric, which holds the two layers together. In a more preferred embodiment, the perforated film or nonwoven fabric layer facing away from the paper is coated with further adhesive to give the laminate a means for sealing the nonwoven fabric or perforated film to itself. In this embodiment, the adhesive has a high melting point that resists opening of the package during high-heat autoclave sterilization. The package can then be re-opened by cohesive failure of the adhesive system when the contents are needed. By coating the sealing adhesive on the nonwoven fabric or the perforated film, no fibers or debris from the paper sheet are loosened in the opening of the sterilized package. The bond strength is such that it qualifies as a permanent or destructive bond.

While the laminate construction is proposed by standard lamination manufacturing procedures, it should be understood that the present invention could be constructed using any known techniques, including heat seal, thermal bonding and sonic sealing.

The following examples set forth various embodiments of the present invention, and are not intended to be limiting in any way.

### EXAMPLE 1

A sheet of paper (Material A) was prepared utilizing conventional papermalcing procedures. The sheet of paper had a basis weight of 40.0 g/m² and contained no filler. The paper web included a wet strength resin of Kymene 557-LX at 1.0% of the paper web weight, and CMC 7LT at 1.0% of the paper web weight. The sheet was coated with a 2.2% solids solution (by weight) of cross-linked polyvinyl alcohol (PVA). It was applied at the size press inside the temperature range of 120-140 degrees Fahrenheit. The sheet was dried, rolled and then cut down to a smaller roll size for lamination, 20.5 inches wide.

### EXAMPLE 2

A perforated film (Material B) was prepared using a 20.5-inch wide roll of nylon 6,6 film supplied by an outside vendor. It was perforated mechanically with the perforations 3 mm apart in a regular repeating pattern to a porosity of nearly 200 Sheffield porosity units with a ¾″ head. The nylon 6,6 film had a weight of 18.0 g/m² and exhibited uniform porosity.

### EXAMPLE 3

A laminated roll was prepared by laminating the 20.5″ wide paper web in Example 1 to the 18 g/m² perforated nylon 6,6 film with a polyethylene adhesive. A laminate was created (Laminate 1) that exhibited air permeability, heat stability and enhanced strength, fit for use in sterilizable packaging.

A second laminated roll was prepared by laminating the same paper web in Example 1 to a roll of 50 g/m² spunbonded polypropylene (Material C). A second laminate (Laminate 2) was created that exhibited air permeability, heat stability and enhanced strength, fit for use in sterilizable packaging.

A third laminated roll was prepared by laminating the same paper web in Example 1 to a roll of 50 g/m² spunbonded polypropylene (Material C). Another coating of adhesive was then applied to the open nonwoven fabric surface of the laminate. A third laminate (Laminate 3) was created that exhibited air permeability, heat stability, enhanced strength, and self-sealing capability with the coated adhesive. Again, this third laminate was fit for use in sterilizable packaging.

The physical attributes of the film, nonwoven fabric and paper webs are set forth in Table 1, below:

TABLE 1
Properties of Materials for Sterilizable
Packaging Laminate Construction

| | Material A | Material B | Material C |
|---|---|---|---|
| | Nylon Film | Paper Web | Spunbond |
| Sample | Perforated | Barrier Sheet | PP nonwoven |
| Basis Weight, g/m² | 14.7 | 40.8 | 47.6 |
| Mullen Burst, psi | 18.0 | 29.7 | >60 |
| Stiffness MD, g | 2.14 | 25.89 | 11.02 |
| Stiffness CD, g | N/A | 12.67 | 5.65 |
| Elmendorf Tear MD, g | 9.0 | 33.0 | 304.0 |
| Elmendorf Tear CD, g | N/A | 36.6 | 656.0 |
| MD Tensile, kg/cm³ | 2.36 | 11.79 | 9.22 |
| CD Tensile, kg/cm³ | N/A | 5.91 | 3.48 |
| MD Wet Tensile, kg/cm³ | N/A | 4.52 | 8.64 |
| CD Wet Tensile, kg/cm³ | N/A | 1.99 | 3.69 |
| Stretch MD, % | N/A | 2.6 | 89.9 |
| Stretch CD, % | N/A | 5.2 | 60.8 |
| Thickness, mil | 1.08 | 2.47 | 3.65 |
| %“ Sheffield Porosity | 184 | 9 | 1267 |

The physical attributes of the three laminates constructed in Example 3, as well as microbial barrier properties of each as compared to several grades of Tyvek® medical packaging material, are set forth in Table 2 below:

TABLE 2
Properties of Sterilizable Packaging Laminates Versus Paper and Tyvek ® Properties

| | | | | 72 # Latex | Tyvek ® | Tyvek ® | Tyvek ® |
|---|---|---|---|---|---|---|---|
| Sample | Laminate 1 | Laminate 2 | Laminate 3 | Paper Pouch | 2FS | S-1059B | S-1073B |
| Basis Weight, g/m² | 74.9 | 94.8 | 100.5 | 109.0 | 56.0 | 65.1 | 75.4 |
| % Barrier Efficiency to | | 94.7 | | | | | |
| Bacteria | | | | | | | |
| Mullen Burst,psi | 35.2 | 34.0 | 36.7 | 60.0 | 131 | 150.0 | 178.0 |
| Elmendorf Tear MD, g | 49.0 | 424.0 | 213.3 | 104.3 | 285.8 | 331.0 | 372.0 |
| Elmendorf Tear CD, g | 51.0 | 1080.0 | 488.0 | 113.9 | 385.6 | 340.2 | 381.0 |
| MD Tensile,kg/cm³ | 14.40 | 15.00 | 15.10 | 17.10 | 16.90 | 19.00 | 22.30 |
| GD Tensile, kg/cm³ | 8.27 | 8.02 | 8.24 | 14.00 | 16.90 | 21.50 | 25.40 |
| MD Wet Tensile kg/cm³ | 7.00 | 8.33 | 7.89 | NA | NA | NA | NA |
| GD Wet Tensile kg/cm³ | 4.25 | 3.90 | 3.99 | NA | NA | NA | NA |
| Stretch MD, % | 2.7 | 2.7 | 2.7 | 4.0 | 18.0 | 18.1 | 20.2 |
| Stretch CD, % | 6.3 | 5.3 | 5.3 | 8.0 | 21.0 | NA | NA |
| Thickness, mil | 5.3 | 10.13 | 9.63 | 5.9 5.9 | NA | NA | |
| Gurley Porosity | >100 | 70.8 | 86.6 | 15.0 | 18.0 | 22.0 | 22.0 |
| Sec/100 cc | | | | | | | |
| 3/4″ Sheffield Porosity | 63 | 130 | 79 | NA | NA | NA | NA |

¹ Tyvek ® and Autoclave Paper Pouch Data from Tyvek ® website,
http://www.tyvek.com/na/medicalpack/english/techinfo/props.html and Tyvek 2FS Product Bulletin
http://www.tyvek.com/na/medicalpack/english/pdf/fs.pdf

### EXAMPLE 4

A laminated roll was prepared by laminating the 20.5″ wide paper web to a 1.0 oz/yd² spunbonded polypropylene nonwoven, using a polyester based adhesive system. The adhesive was applied to the paper using a gravure system, and the nonwoven was adhered to the adhesive layer, using a nip roller system. A laminate was created which exhibited air permeability, heat stability and enhanced tensile and burst strength. The laminate is fit for use in sterilizable and other packaging, where greater strength is required than can be achieved by paper alone, and permeability is required, along with a bacterial barrier and/or dust control. The physical attributes of the spunbonded polypropylene nonwoven by itself (identified as “B”) and the nonwoven/paper laminate (identified as “A”) are set forth in Table 3 below.

A laminated roll was prepared by laminating the 20.5″ wide paper web to a 0.75 oz/yd² spunbonded polypropylene nonwoven, using a polyester based adhesive system. The adhesive was applied to the paper using a gravure system, and the nonwoven was adhered to the adhesive layer, using a nip roller system. A laminate was created which exhibited air permeability, heat stability and enhanced tensile and burst strength. The laminate is fit for use in sterilizable and other packaging, where greater strength is required than can be achieved by paper alone, and permeability is required, along with a bacterial barrier and/or dust control. The physical attributes of the spunbonded polypropylene nonwoven by itself (identified as “D”) and the nonwoven/paper laminate (identified as “C”) are set forth in Table 3 below.

A laminated roll was prepared by laminating the 20.5″ wide paper web to a 0.75 oz/sq² spunbonded polyester nonwoven, using a polyester based adhesive system. The adhesive was applied to the paper using a gravure system, and the nonwoven was adhered to the adhesive layer, using a nip roller system. A laminate was created which exhibited air permeability, heat stability and enhanced tensile and burst strength. The laminate is fit for use in sterilizable and other packaging, where greater strength is required than can be achieved by paper alone, and permeability is required, along with a bacterial barrier and/or dust control. The physical attributes of the spunbonded polyester nonwoven by itself (identified as “F”) and the nonwoven/paper laminate (identified as “E”) are set forth in Table 3 below.

TABLE 3
Properties of Nonwoven Fabric Layer Versus Nonwoven/Paper Laminate

| | A | | C | | E | |
|---|---|---|---|---|---|---|
| | PP 75 | B | PP 100 | D | PET 75 | F |
| | Paper & | PP75 | Paper & | PP 100 | Paper & | PET 75 |
| Sample | Laminate | Nonwoven | Laminate | Nonwoven | Laminate | Nonwoven |
| Basis Weight, g/m² | 221.22 | 25.25 | 268.33 | 33.11 | 256.08 | 27.07 |
| Caliper, mil | 12.26 | 6.46 | 16.78 | 8.18 | 10.77 | 6.78 |
| Density, g/cm³ | 0.710 | 0.154 | 0.630 | 0.159 | 0.936 | 0.157 |
| Bulk, cm³/g | 1.408 | 6.500 | 1.588 | 6.275 | 1.068 | 6.362 |
| Burst, psi | 41.50 | 26.80 | 57.10 | 27.20 | 44.10 | 26.80 |
| Burst Index | 1.29 | 7.31 | 1.47 | 5.66 | 1.19 | 6.82 |
| (kPa = m³/g) | | | | | | |
| Elmendorf Tear MD, g | 528.00 | 545.60 | 651.20 | 596.80 | 289.60 | 241.60 |
| Tear Index (mN = m²/g) | 23.41 | 211.95 | 23.80 | 176.77 | 11.09 | 87.53 |
| Elmendorf Tear CD, g | 534.40 | 528.00 | 683.20 | * | 366.40 | * |
| Tear Index (kPa = m²/g) | 23.69 | 205.11 | 24.97 | | 14.03 | |
| MD Tensile, lb/in | 34.41 | 4.68 | 45.55 | 9.15 | 37.11 | 5.77 |
| CD Tensile, lb/in | 23.02 | 6.19 | 32.04 | 4.76 | 22.84 | 2.70 |
| Stretch MD, % | 2.256 | 46.563 | 2.677 | 41.660 | 2.033 | 19.065 |
| Stretch CD, % | 6.550 | 56.883 | 7.029 | 38.728 | 5.771 | 25.556 |
| MD Tensile Index | 27.25 | 32.40 | 29.73 | 48.42 | 25.38 | 37.27 |
| (N = m/g) | | | | | | |
| CD Tensile Index | 18.23 | 42.82 | 20.91 | 25.19 | 15.62 | 17.46 |
| (N = m/g) | | | | | | |

All figures above are averages
Methods: Basis Weight - TAPPI Test Method T 410 om-98
Caliper - TAPPI Test Method T 411 om-97
Burst - TAPPI Test Method T 403 om-97
Tear - TAPPI Test Method T 414 om-98
Porosity - TAPPI Test Method T 460 om-96
Tensile - TAPPI Test Method T 494 om 96
*sample was unable to be torn in the cross direction

If not otherwise stated herein, it may be assumed that all components and/or processes described heretofore may, if appropriate, be considered to be interchangeable with similar components and/or processes disclosed elsewhere in the specification, unless an express indication is made to the contrary.

It should be appreciated that the laminate and method of the present invention may be configured and conducted as appropriate for any context at hand. The embodiments described above are to be considered in all respects only as illustrative and not restrictive. All changes which come within the meaning and range of equivalency of the claims are to be embraced within their scope.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims.

Nothing in the above description is meant to limit the present invention to any specific materials, geometry, or orientation of parts. Many part/orientation substitutions are contemplated within the scope of the present invention. The embodiments described herein were presented by way of example only and should not be used to limit the scope of the invention.

Although the invention has been described in terms of particular embodiments in an application, one of ordinary skill in the art, in light of the teachings herein, can generate additional embodiments and modifications without departing from the spirit of, or exceeding the scope of, the claimed invention. Accordingly, it is understood that the descriptions herein are proffered by way of example only to facilitate comprehension of the invention and should not be construed to limit the scope thereof.

Although specific embodiments of the present invention have been described herein, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention.

The present invention has been described in considerable detail in order to comply with the patent laws by providing full public disclosure of at least one of its forms. However, such detailed description is not intended in any way to limit the broad features or principles of the present invention, or the scope of the patent to be granted.

What is claimed is:

1. A sterilizable laminate comprising:
a. a layer of nonwoven fabric; and
b. a paper layer laminated thereto.

2. The sterilizable laminate of claim 1, wherein said nonwoven fabric is selected from the group consisting of spunbonded polyester (PET), polypropylene (PP), polyethylene (PE), nylon 6 or nylon 6,6 (N), polytetrafluoroethylene (PTFE), polyvinylfluoride (PVF), polyvinylchloride (PVC), polyvinylidenefluoride (PVDF) and polyvinylidenechloride (PVDC).

3. The sterilizable laminate of claim 2, wherein said nonwoven fabric has a weight of about 13 g/m² to about 130 g/m².

4. The sterilizable laminate of claim 3, wherein said nonwoven fabric further comprises a biocide or bactericide.

5. The sterilizable laminate of claim 1, wherein said paper layer comprises a fibrous web and a solution applied to said fibrous web to form said paper layer, said solution comprising polyvinyl alcohol and one or more property-enhancing components.

6. The sterilizable laminate of claim 5, wherein said web comprises cellulose fibers.

7. The sterilizable laminate of claim 5, wherein said web comprises synthetic fibers.

8. The sterilizable laminate of claim 5, wherein said web comprises cellulose and synthetic fibers.

9. The sterilizable laminate of claim 5, wherein said web further comprises one or more wet end additives.

10. The sterilizable laminate of claim 9, wherein said one or more wet end additives comprises a first wet end additive for providing water holdout to said web, and a second wet end additive for providing strength to said web.

11. The sterilizable laminate of claim 10, wherein said first wet end additive comprises an alkaline sizing agent.

12. The sterilizable laminate of claim 11, wherein said alkaline sizing agent comprises from about 0.1 percent to about 5 percent by weight, based on the total weight of said web.

13. The sterilizable laminate of claim 12, wherein said alkaline sizing agent comprises from about 0.2 percent to about 2 percent by weight, based on the total weight of said web.

14. The sterilizable laminate of claim 13, wherein said alkaline sizing agent comprises from about 0.5 percent to about 1 percent by weight, based on the total weight of said web.

15. The sterilizable laminate of claim 11, wherein said alkaline sizing agent comprises alkyl succinic anhydride (ASA) in a water based emulsion with fatty acids.

16. The sterilizable laminate of claim 11, wherein said alkaline sizing agent comprises alkyl ketene dimer (AKD) in a water based emulsion with fatty acids.

17. The sterilizable laminate of claim 10, wherein said second wet end additive comprises a cellulose derivative and a wet strength resin.

18. The sterilizable laminate of claim 17, wherein said cellulose derivative comprises from about 0.1 percent to about 5 percent by weight, based on the total weight of said web.

19. The sterilizable laminate of claim 18, wherein said cellulose derivative comprises from about 0.3 percent to about 3 percent by weight, based on the total weight of said web.

20. The sterilizable laminate of claim 19, wherein said cellulose derivative comprises from about 1 percent to about 2 percent by weight, based on the total weight of said web.

21. The sterilizable laminate of claim 17, wherein said cellulose derivative comprises carboxymethyl cellulose (CMC).

22. The sterilizable laminate of claim 17, wherein said wet strength resin comprises from about 0.1 percent to about 5 percent by weight, based on the total weight of said web.

23. The sterilizable laminate of claim 22, wherein said wet strength resin comprises from about 0.3 percent to about 3 percent by weight, based on the total weight of said web.

24. The sterilizable laminate of claim 23, wherein said wet strength resin comprises from about 1 percent to about 2 percent by weight, based on the total weight of said web.

25. The sterilizable laminate of claim 17, wherein said wet strength resin comprises Kymene.

26. The sterilizable laminate of claim 5, wherein said polyvinyl alcohol is a fully hydrolyzed polyvinyl alcohol.

27. The sterilizable laminate of claim 5, wherein said polyvinyl alcohol is a medium molecular weight polyvinyl alcohol.

28. The sterilizable laminate of claim 5, wherein said solution comprises from about 0.5 percent by weight to about 11 percent by weight, based on the total weight of said laminate.

29. The sterilizable laminate of claim 28, wherein said solution comprises from about 1 percent by weight to about 10 percent by weight, based on the total weight of said laminate.

30. The sterilizable laminate of claim 29, wherein said solution comprises from about 2 percent by weight to about 7 percent by weight, based on the total weight of said laminate.

31. A medical packaging material comprising:
a. a layer of perforated film; and
b. a paper layer laminated thereto.

32. The medical packaging material of claim 31, wherein said perforated film is selected from the group consisting of spunbonded polyester (PET), polypropylene (PP), nylon 6 or nylon 6,6 (N), polytetrafluoroethylene (PTFE), polyvinylfluoride (PVF), polyvinylchloride (PVC), polyvinylidenefluoride (PVDF) and polyvinylidenechloride (PVDC).

33. The medical packaging material of claim 32, wherein said perforated film has a weight of about 13 g/m² to about 100 g/m².

34. The medical packaging material of claim 33, wherein said perforated film further comprises a biocide or bactericide.

35. The medical packaging material of claim 31, wherein said paper layer comprises a fibrous web and a solution applied to said fibrous web to form said paper layer, said solution comprising polyvinyl alcohol and one or more property-enhancing components.

36. The medical packaging material of claim 35, wherein said web comprises cellulose fibers.

37. The medical packaging material of claim 35, wherein said web comprises synthetic fibers.

38. The medical packaging material of claim 35, wherein said web comprises cellulose and synthetic fibers.

39. The medical packaging material of claim 35, wherein said web further comprises one or more wet end additives.

40. The medical packaging material of claim 39, wherein said one or more wet end additives comprises a first wet end additive for providing water holdout to said web, and a second wet end additive for providing strength to said web.

41. The medical packaging material of claim 40, wherein said first wet end additive comprises an alkaline sizing agent.

42. The medical packaging material of claim 41, wherein said alkaline sizing agent comprises from about 0.1 percent to about 5 percent by weight, based on the total weight of said web.

43. The medical packaging material of claim 42, wherein said alkaline sizing agent comprises from about 0.2 percent to about 2 percent by weight, based on the total weight of said web.

44. The medical packaging material of claim 43, wherein said alkaline sizing agent comprises from about 0.5 percent to about 1 percent by weight, based on the total weight of said web.

45. The medical packaging material of claim 41, wherein said alkaline sizing agent comprises alkyl succinic anhydride (ASA) in a water based emulsion with fatty acids.

46. The medical packaging material of claim 41, wherein said alkaline sizing agent comprises alkyl ketene dimer (AKD) in a water based emulsion with fatty acids.

47. The medical packaging material of claim 40, wherein said second wet end additive comprises a cellulose derivative and a wet strength resin.

48. The medical packaging material of claim 47, wherein said cellulose derivative comprises from about 0.1 percent to about 5 percent by weight, based on the total weight of said web.

49. The medical packaging material of claim 48, wherein said cellulose derivative comprises from about 0.3 percent to about 3 percent by weight, based on the total weight of said web.

50. The medical packaging material of claim 49, wherein said cellulose derivative comprises from about 1 percent to about 2 percent by weight, based on the total weight of said web.

51. The medical packaging material of claim 47, wherein said cellulose derivative comprises carboxymethyl cellulose (CMC).

52. The medical packaging material of claim 47, wherein said wet strength resin comprises from about 0.1 percent to about 5 percent by weight, based on the total weight of said web.

53. The medical packaging material of claim 52, wherein said wet strength resin comprises from about 0.3 percent to about 3 percent by weight, based on the total weight of said web.

54. The medical packaging material of claim 53, wherein said wet strength resin comprises from about 1 percent to about 2 percent by weight, based on the total weight of said web.

55. The medical packaging material of claim 47, wherein said wet strength resin comprises Kymene.

56. The medical packaging material of claim 35, wherein said polyvinyl alcohol is a fully hydrolyzed polyvinyl alcohol.

57. The medical packaging material of claim 35, wherein said polyvinyl alcohol is a medium molecular weight polyvinyl alcohol.

58. The medical packaging material of claim 35, wherein said solution comprises from about 0.5 percent by weight to about 11 percent by weight, based on the total weight of said packaging material.

59. The medical packaging material of claim 58, wherein said solution comprises from about 1 percent by weight to about 10 percent by weight, based on the total weight of said packaging material.

60. The medical packaging material of claim 59, wherein said solution comprises from about 2 percent by weight to about 7 percent by weight, based on the total weight of said packaging material.

61. A method of making a sterilizable laminate for use in medical packaging, said method comprising the lamination of a nonwoven fabric layer to a paper layer.

62. The method of claim 61, wherein said nonwoven fabric is selected from the group consisting of spunbonded polyester (PET), polypropylene (PP), polyethylene (PE), nylon 6 or nylon 6,6 (N), polytetrafluoroethylene (PTFE), polyvinylfluoride (PVF), polyvinylchloride (PVC), polyvinylidenefluoride (PVDF) and polyvinylidenechloride (PVDC).

63. The method of claim 62, wherein said nonwoven fabric has a weight of about 13 g/m² to about 130 g/m².

64. The method of claim 63, wherein said paper layer comprises a fibrous web and a solution applied to said fibrous web to form said paper layer, said solution comprising polyvinyl alcohol and one or more property-enhancing components.

65. The method of claim 64, wherein said web further comprises a first wet end additive for providing water holdout to said web, and a second wet end additive for providing strength to said web.

66. The method of claim 65, wherein said first wet end additive comprises an alkaline sizing agent.

67. The method of claim 66, wherein said alkaline sizing agent comprises alkyl ketene dimer (AKD) in a water based emulsion with fatty acids.

68. The method of claim 65, wherein said second wet end additive comprises a cellulose derivative and a wet strength resin.

69. The method of claim 68, wherein said cellulose derivative comprises carboxymethyl cellulose (CMC).

70. The method of claim 68, wherein said wet strength resin comprises Kymene.

71. A method of making a medical packaging material, said method comprising the lamination of a perforated film layer to a paper layer.

72. The method of claim 71, wherein said perforated film is selected from the group consisting of spunbonded polyester (PET), polypropylene (PP), nylon 6 or nylon 6,6 (N), polytetrafluoroethylene (PTFE), polyvinylfluoride (PVF), polyvinylchloride (PVC), polyvinylidenefluoride (PVDF) and polyvinylidenechloride (PVDC).

73. The method of claim 72, wherein said perforated film has a weight of about 13 g/m² to about 130 g/m².

74. The method of claim 73, wherein said paper layer comprises a fibrous web and a solution applied to said fibrous web to form said paper layer, said solution comprising polyvinyl alcohol and one or more property-enhancing components.

75. The method of claim 74, wherein said web further comprises a first wet end additive for providing water holdout to said web, and a second wet end additive for providing strength to said web.

76. The method of claim 75, wherein said first wet end additive comprises an alkaline sizing agent.

77. The method of claim 76, wherein said alkaline sizing agent comprises alkyl ketene dimer (AKD) in a water based emulsion with fatty acids.

78. The method of claim 75, wherein said second wet end additive comprises a cellulose derivative and a wet strength resin.

79. The method of claim 78, wherein said cellulose derivative comprises carboxymethyl cellulose (CMC).

80. The method of claim 78, wherein said wet strength resin comprises Kymene.

81. A sterilizable package comprising:
a. a container having at least one opening for inserting at least one device into said container; and
b. a laminate applied to said container so as to completely cover said opening and thereby seal said at least one device within said container,
wherein said laminate comprises a nonwoven fabric layer laminated to a paper layer.

82. The package of claim 81, wherein said nonwoven fabric is selected from the group consisting of spunbonded polyester (PET), polypropylene (PP), polyethylene (PE), nylon 6 or nylon 6,6 (N), polytetrafluoroethylene (PTFE), polyvinylfluoride (PVF), polyvinylchloride (PVC), polyvinylidenefluoride (PVDF) and polyvinylidenechloride (PVDC).

83. The package of claim 82, wherein said nonwoven fabric has a weight of about 13 g/m² to about 130 g/m².

84. The package of claim 83, wherein said paper layer comprises a fibrous web and a solution applied to said fibrous web to form said paper layer, said solution comprising polyvinyl alcohol and one or more property-enhancing components.

85. The package of claim 84, wherein said web further comprises a first wet end additive for providing water holdout to said web, and a second wet end additive for providing strength to said web.

86. The package of claim 85, wherein said first wet end additive comprises an alkaline sizing agent.

87. The package of claim 86, wherein said alkaline sizing agent comprises alkyl ketene dimer (AKD) in a water based emulsion with fatty acids.

88. The package of claim 85, wherein said second wet end additive comprises a cellulose derivative and a wet strength resin.

89. The method of claim 88, wherein said cellulose derivative comprises carboxymethyl cellulose (CMC).

90. The method of claim 88, wherein said wet strength resin comprises Kymene.

91. A sterilizable package comprising:
a. a container having at least one opening for inserting at least one device into said container; and
b. a laminate applied to said container so as to completely cover said opening and thereby seal said at least one device within said container,
wherein said laminate comprises a perforated film layer laminated to a paper layer.

92. The package of claim 91, wherein said perforated film is selected from the group consisting of spunbonded polyester (PET), polypropylene (PP), nylon 6 or nylon 6,6 (N), polytetrafluoroethylene (PTFE), polyvinylfluoride (PVF), polyvinylchloride (PVC), polyvinylidenefluoride (PVDF) and polyvinylidenechloride (PVDC).

93. The package of claim 92, wherein said perforated film has a weight of about 13 g/m² to about 130 g/m².

94. The package of claim 93, wherein said paper layer comprises a fibrous web and a solution applied to said fibrous web to form said paper layer, said solution comprising polyvinyl alcohol and one or more property-enhancing components.

95. The package of claim 94, wherein said web further comprises a first wet end additive for providing water holdout to said web, and a second wet end additive for providing strength to said web.

96. The package of claim 95, wherein said first wet end additive comprises an alkaline sizing agent.

97. The package of claim 96, wherein said alkaline sizing agent comprises alkyl ketene dimer (AKD) in a water based emulsion with fatty acids.

98. The package of claim 95, wherein said second wet end additive comprises a cellulose derivative and a wet strength resin.

99. The package of claim 98, wherein said cellulose derivative comprises carboxymethyl cellulose (CMC).

100. The package of claim 98, wherein said wet strength resin comprises Kymene.
